(19) United States
(12) Patent Application Publication
(10) Pub. No.: US 2009/0304481 A1
(43) Pub. Date: Dec. 10, 2009

(54) STEEL BRIDGE PLATE

(75) Inventors: Hugh W. Larsen, Milford, MI (US); Ralph E. Mantela, White Lake, MI (US); George Marks, Commerce Township, MI (US); Robert Popovczak, Howell, MI (US)

Correspondence Address: YOUNG BASILE, 3001 WEST BIG BEAVER ROAD, SUITE 624, TROY, MI, 48084, US

(73) Assignee: Michigan Scientific Transportation Products, L.L.C., Milford, MI (US)

(21) Appl. No.: 12/134,460

(22) Filed: Jun. 6, 2008

(51) Int. Cl. B65G 67/00

(52) U.S. Cl. 414/340

(57) ABSTRACT

A bridge plate assembly is formed of dual phase steel for interconnecting two rail cars and supporting the weight of a vehicle moving between the rail cars. The bridge plate assembly includes a bridge plate with a substantially continuous top surface having a pair of troughs. The bottom surface of the bridge plate assembly has a box formation provided by a bottom panel spanning an area between the pair of troughs.

### FIELD OF THE INVENTION

The present invention relates to a structure providing passage over a gap, and more specifically, an apparatus for supporting a vehicle moving between two rail cars.

### BACKGROUND

Vehicles can be transported by rail from a manufacturer to a dealer or distributor. Rail cars for transporting vehicles can define one or more cavities in which vehicles can be housed during transport. The cavity can define openings at both ends of the rail car. A vehicle can be driven through either opening. During the loading and unloading of rail cars with vehicles, two or more rail cars can be engaged with respect to one another such that openings of the rail car cavities can be adjacent to one another. However, a gap can be defined between the rail cars such that a vehicle cannot move between rail cars without means for spanning the gap. A bridge plate can span the gap defined between the openings of the adjacent rail cars and a vehicle can pass from one rail car to another rail car.

Prior art bridge plates are formed from aluminum or are made of another material that can not withstand being continuously dropped from the rail cars. In addition, prior art bridge plates are substantially flat and are planar along edges. A traction surface is applied, typically by spraying, to prior art bridge plates several times over the course of their useful life to enhance traction of vehicles moving between rail cars. Also, prior art bridge plates are painted bright colors to enhance visibility. However, the traction surface and the paint wear quickly and must be reapplied. The contour of the top surface of the current bridge plate is such that it can collect rain water that may fall while the bridge plate is installed. In some cases the water freezes and forms ice that bonds to the bridge plate and increases its weight. Prior art bridge plates are rotatingly engaged with respect to a rail car with a handle that is accessible only adjacent a downwardly facing surface of the prior art bridge plate.

### SUMMARY

In one aspect of the invention an apparatus for supporting a vehicle moving between two rail cars is provided. The apparatus includes a bridge plate formed of steel having two opposing ends and including a substantially continuous top surface and a complementary bottom surface. A pin assembly is also provided attached to one end of the bridge plate. A bottom panel is secured to the bottom surface of the bridge plate. The bottom panel has a first and a second end. A ramp portion is attached to the second end of the bottom panel and terminates at the other end of the bridge plate. The ramp portion terminates at an end of the apparatus having the height less than or equal to one inch.

In another aspect of the invention the top surface of the bridge plate is configured with a pair of parallel elongate troughs extending from one opposing end to another opposing end.

In yet another aspect of the invention the bottom panel spans between the bottom surfaces on the pair of parallel elongate troughs forming a box formation.

### BRIEF DESCRIPTION OF THE DRAWINGS

FIG. 1 is a perspective top view of a bridge plate assembly illustrating a bridge plate and pin assembly according to the present invention;

FIG. 2 is a perspective bottom view of the bridge plate assembly shown in FIG. 1 with a bottom panel installed;

FIG. 2A is a side view of the bottom panel shown in FIG. 2;

FIG. 2B is a side view of the bridge plate shown in FIG. 1;

FIG. 3 is a bottom view of the bridge plate with the bottom panel removed to disclose certain features;

FIG. 4 is an exploded view the pin assembly shown in FIG. 1; and

FIG. 5 is a sectional view of the slide assembly shown in FIG. 4 taken along lines 5-5.

### DETAILED DESCRIPTION OF THE EMBODIMENT

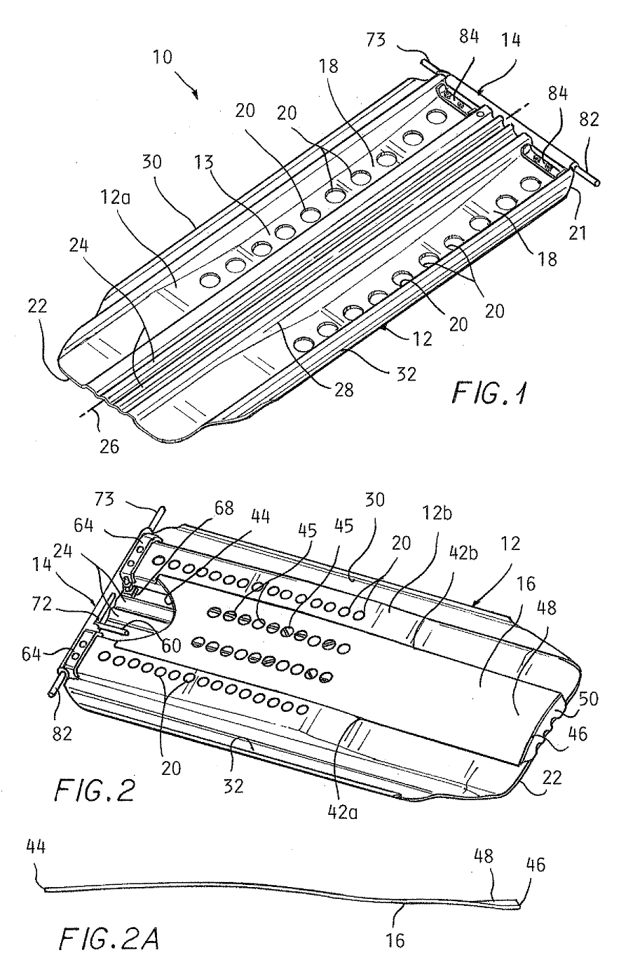

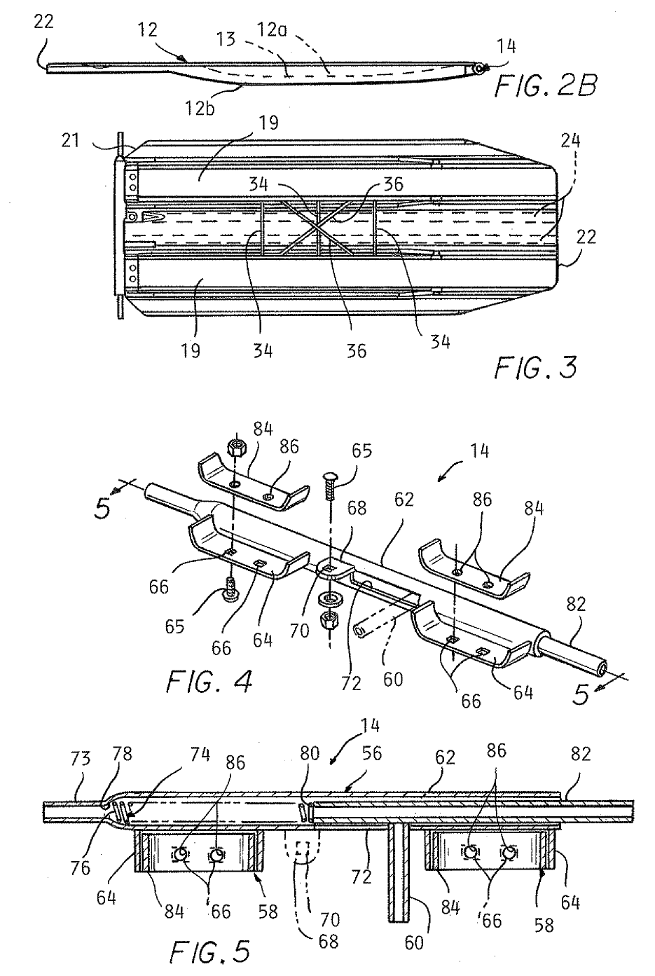

Referring to FIGS. 1, 2, 2a and 2b, the present invention provides a bridge plate assembly 10 including a bridge plate 12, a pin assembly 14 and a bottom panel 16. The bridge plate assembly 10 can be positioned between two rail cars to span a gap or chasm defined between the rail cars and support movement of a vehicle between the rail cars. The bridge plate 12 is formed of dual phase steel as described in detailed hereinafter. The bridge plate 12 has an upper surface 12a and a bottom surface 12b. The bridge plate 12 further has a first end 21 for positioning the pin assembly 14 and a second or tip end 22.

The bridge plate 12 extends between the first end 21 and the second end or tip end 22 along a longitudinal axis 26. A middle portion 28 can be defined between the first end 21 and the second end 22. The bridge plate 12 can extend a predetermined length along the longitudinal axis 26. For example and not limitation, the bridge plate 12 can be 53-56 inches long and have a minimum of 21.5 inches of width. Furthermore, the bridge plate 12 can be 56 inches long and 22 inches wide. The width of the second end or tip end 22 can be less than the width of the middle portion 28. The height and width of the tip end 22 is less than the height and width of the middle portion 28 to enhance the engagement of the tip end 22 with respect to a rail car. In particular the tip end 22 is configured to provide clearance for rail car and door lock pin stops. To pass certain U.S. test procedures, the height of the bridge plate assembly 10 at the tip end 22 is less than or equal to 1.0 inch. In addition, the configuration of the tip end 22 enhances the likelihood that the tip end 22 can rest flat with respect to the indoor tracks of the rail car.

The upper surface 12a has a pair of troughs 18 running the axial length of the bridge plate 12. As seen in FIG. 2B, the troughs 18 are deeper and form a well 13 in the center section of the bridge plate 12. In each trough 18 there is a plurality of through apertures 20. The apertures 20 are orientated in a linear configuration. The through apertures 20 extend in the deeper well portions 13 of the pair of troughs 18 as shown in FIG. 1. As the pair of troughs 18 ramp upward toward the tip end 22, the through apertures 20 terminate. The through apertures 20 provide a means of reducing the weight of the bridge plate 12 without impeding structural integrity, and further for providing drainage ports for rain, debris or other material.

Each trough 18 is separated from each other by narrow center grooves or ripples 24 extending the axial length of the bridge plate 12. The center ripples 24 prevent buckling of the bridge plate 12.

Referring to FIGS. 1 and 2, the bridge plate 12 can also include rolled lateral edges. The rolled lateral edges 30 and 32 provide a means for handling the bridge plate 12 for positioning and removing the bridge plate 12 with respect to the rail car. The rolled lateral edges 30 and 32 are integrally formed with the bridge plate 12 and define the first 30 and second side 32 of the bride plate 12. The rolled lateral edges 30 and 32 enhance the likelihood that the bridge plate 12 can be safely grasped or gripped by an operator. The rolled lateral edges 30 and 32 also provide stiffness and strength to the bridge plate 12.

Looking at FIG. 3, the bottom surface 12b of the bridge plate 12 is a mirror image of the upper side 12a. From the bottom surface 12b, the pair of troughs 18 appears as raised elongate sections 19. The raised sections 19 are separated by the center ripples 24 as shown in phantom. To provide added strength to the pair of troughs portions 18 a plurality of bulk heads span between the raised sections 19 and are welded at each end. Bulkheads 34 are strips of steel that can be positioned to perpendicularly traverse the center ripples 24. Other bulkheads 36 can span the center grooves 24 in a cross configuration. The bulkheads 34 and 36 can be integrally formed with the bridge plate 12 or can be separate features welded or otherwise attached to the raised sections 19. The bulkheads 34, 36 add additional strength and stiffness to the pair of troughs 18 and center ripples 24. While the bulkheads 34 and 36 provide additional strength to the bridge plate 12, the bulkheads 34 and 36 add minimal weight to the bridge plate assembly 10.

The bridge plate assembly 10 forms a box configuration on the bottom surface 12b of the bridge plate 12 with the bottom panel 16. The box configuration provides added strength to the bridge plate assembly 10. The bottom panel 16 is welded to the bottom surface 12b of the bridge plate 12, as shown in FIG. 2 covering the bulkheads 34, 36. The bottom panel 16 is positioned directly over the center ripples 24 so that lateral side edges 42a and 42b of the bottom panel 16 lay over the raised sections 19 of the bottom surface 12b. The box formation is formed by the bottom panel 16, the inside walls of the pair of troughs 18 and the center ripples 24. The bottom panel 16 has a plurality of through apertures 45 to reduce the weight of the assembly 10. The plurality of apertures 45 preferably end at approximately the same lateral location as the bridge plate 12 when the bottom panel 16 is installed thereon. Terminating the apertures 45 before the end of the bottom panel 16 also helps to prevent torsional bending of the assembly 10.

Referring to FIGS. 2 and 2A the bottom panel 16 has a first end 44 and a second end 46. The first end 44 defines a slotted end for access to the handle 60 of the pin assembly 14 as will be discussed hereinafter. The second end 46 of the bottom panel 16 provides a bowed surface 48. A ramp section 50 can be welded to the second end 46 of the bottom panel 16 to accommodate and to resist interference with the rail car deck hardware. The bowed surface 48 extends approximately the last five inches at the end 46 of the bottom panel 16. The bowed surface 48 and box formation of the bridge plate assembly 10 minimizes torsional bending of the assembly 10 during testing and use.

The ramped section 50 of the bottom panel 16 insures that the tip end 22, 46 of the combination bridge plate 12 and bottom panel 16 has a height less than or equal to 1.0 inch. The bottom panel 16 is positioned on the back surface 12a of the bridge plate 12 so that the side edges 42a and 42b of the bottom panel 16 are positioned evenly on the rigid sections 19. The second end 46 is placed adjacent the second or tip end 22 of the bridge plate 12 leaving minimal room for the ramped section 50, so that the end of the ramped section 50 meets the terminating end of the tip end 22 on the bridge plate 132. As a result the first end 44 of the bottom panel 16 is positioned so that the slotted end 44 provides access to the handle 60 of the pin assembly 14. The bottom panel 16 is connected to the raised sections 19 on the bottom 12b of the bridge plate 12 by robotic welding which includes a continuous weld in a controlled process starting from one end. The robotic welding pattern allows for a narrower weld which does not diminish strength of the weld but is designed to resist fatigue cracking.

Referring now to FIGS. 4 and 5, the pin assembly 14 can rotatingly engage the bridge plate 12 with respect to a rail car. The pin assembly 14 can be removably associated with respect to the bridge plate 12. For example, if either the pin assembly 14 of the bridge plate 12 is damaged, the damaged component can be replaced with respect to the other rather than discarding of both components.

The pin assembly 14 can include a tube pin assembly 56 and fastener means 58 for removably associating the tube pin assembly 56 with respect to the bridge plate 12. The first end 21 of the bridge plate 12 engages the tube pin assembly 56. The tube pin assembly 56 includes a tube 62. Pair of side brackets 64 are axially aligned and fixedly connected to the exterior length of the tube 62. Each of the side brackets 64 has a pair of apertures 66 for receiving bolts 65. The side brackets 64 are configured and positioned for aligning with the bottom surface 12b of the bridge plate 12 adjacent the first end 21; and further for positioning over the raised sections 19. The tube 62 further has a tab 68 centrally located along the axial length of tube 62 and having a through aperture 70 therein. The middle tab 68 is positioned between the two side brackets 64 and orientated for positioning against the bottom side 12b of the bridge plate 12. The middle tab 68 has a through aperture for receiving a bolt 65. Below the middle tab 68 is an elongate through slot 72 extending in the axial length of the tube 62. The elongate slots 72 provide an access for the handle 60 and a means of limiting the movement of the handle 60. One end 73 of the tube 62 undergoes a swaging process to reduce the diameter of the first end 73 of the tube 62. A spring 74 is positioned within the tube 62. The spring 74 has one end 76 secured and/or abutting the mouth 78 of the swaged end 73 of tube 62. The opposing end 80 of the spring abuts against a pin 82 inserted into the tube 62. The spring 74 biases the pin 82 to an extended position so that the pin 82 extends beyond the tube 62 when in the extended position. The diameter of the pin 82 and the swaged end 73 of the tube 62 are essentially the same for insertion into corresponding apertures in the end of the rail cars.

The handle 60 is fixedly connected to the pin 82 and extends through the slot 72. The handle 60 can be accessed from the downward facing bottom surface 12b of the bridge plate 12. The handle 60 can be engaged by an operator to move the pin 82 along the longitudinal axis of the tube 60 from an extend position into a retracted position, compressing the biasing means/spring 74. The slot 72 limits the movement of the pin 74 within the tube 62.

As added reinforcement to the bridge plate 12, another pair of side brackets 84 are connected to the pin assembly 14. The pair of side brackets 84 are configured and positioned under the pair of troughs 18 on the top side 12a of the bridge plate 12. The side brackets 84 have apertures 86 positioned for alignment with the apertures 66 and the lower side brackets 64. The bridge plate 12 has corresponding apertures (not shown). Bolts 65 can secure the lower side brackets 64 to the upper side brackets 84 with the bridge plate 12 secured therebetween.

The bridge plate 12 is fabricated from dual phase steel laser cut to a blank shape having a width wider than the final product. The optimum thickness of the blank shape is 1.4 mm.-1.6 mm. The material goes through a two step process in which the material slides in from its edges 30,32 forming the two troughs. The second step of sliding the edges 30,32 of the material forms three ripples 24 between the troughs 18. The deeper the ripples 24, the stronger the final bridge plate 12. However to prevent interference with the rail car deck hardware the maximum depth of the ripples 24 is 1.0 inches and preferably 0.5 inches.

What is claimed is:

1. An apparatus for supporting a vehicle moving between two rail cars comprising:
a bridge plate formed of dual phase steel having two opposing ends and including a substantially continuous top surface and a bottom surface;
a bottom panel secured to the bottom surface of the bridge plate said bottom panel having a first end and a second end; and
a ramp portion attached to the second end of the bottom panel and terminating at one of the opposing ends of the bridge plate and said ramp portion and bottom panels terminating at an end of the apparatus having a height less than or equal to one inch.

2. The apparatus of claim 1 wherein the top surface is configured with a pair of parallel elongate troughs extending from one opposing end to the other opposing end.

3. The apparatus of claim 2 wherein the bottom panel spans between bottom surfaces of the pair of parallel elongate troughs defining a box formation.

4. The apparatus of claim 3 wherein pair of parallel elongate troughs have a plurality of apertures spaced therein.

5. The apparatus of claim 4 wherein the apparatus has a weight less than or equal to forty pounds

6. The apparatus of claim 1, further comprising a pin assembly attached to the other one of the opposing ends of the bridge plate.

7. The apparatus of claim 6 wherein the pin assembly comprises: at least one handle.

8. The apparatus of claim 7 wherein the pin assembly engages the bridge plate with respect to a rail car.

9. The apparatus of claim 7, wherein the pin assembly includes a tube with one swaged end, said tube having cylindrical interior having a spring therein adjacent to the swaged end and pin having one end abutting the spring and an opposing end exposed from the tube.

10. The apparatus of claim 9, wherein the at least one handle is attached to the pin.

11. The apparatus of claim 8 wherein the first end of the bottom panel is slotted for access to the handle in the pin assembly and the second end has a bowed formation.

12. The apparatus of claim 2 wherein the bottom panel has a pair of lateral edges and one of the lateral edges is connected to one elongate trough and the other lateral edge is connected to the other elongate trough.

13. The apparatus of claim 12 further comprising at least one bulkhead connected to the bottom surface of the bridge plate spanning between the pair of elongate trough.

14. The apparatus of claim 12, further comprising a plurality of bulkheads connected to the bottom surface of the bridge plate spanning between the pair of elongate trough and at least one pair of bulkheads are placed in an X formation.

15. The apparatus of claim 14, wherein the at least one pair of bulkheads are disposed between the bottom surface of the bridge plate and the bottom panel.

16. The apparatus of claim 1, wherein the bridge plate has a pair of rolled lateral edges for facilitating handling of the apparatus.
